(19) United States
(12) Patent Application Publication
(10) Pub. No.: US 2005/0242554 A1
(43) Pub. Date: Nov. 3, 2005

(54) Seat load measuring device and occupant protection system using the same

(75) Inventor: Hiroaki Fujii, Hikone-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/113,278

(22) Filed: Apr. 25, 2005

(30) Foreign Application Priority Data
Apr. 28, 2004 (JP) 2004-133507
May 31, 2004 (JP) 2004-161162

(51) Int. Cl. B60R 21/00; B60R 21/32

(52) U.S. Cl. 280/735; 180/268; 180/273

(57) ABSTRACT

A seat load measuring device which can reduce the number of parts, simplify the structure, and can reduce the cost of the device, and an occupant protection system using the same. A sensor connector that is detachably connected to a sensor side connector of a load sensor is integrated with an electronic control unit of an occupant protection device. In other words, the ECU is integrated within the seat load measuring device. Therefore, a harness for connecting the sensor connector and the electronic control unit can be eliminated. Consequently, the number of harnesses can be reduced by one, and hence the structure of the seat load measuring device can be further simplified and the cost can be reduced correspondingly. Clips for fixing the unnecessary harness can also be eliminated. Furthermore, the electronic control unit can be fixed without using a special bracket by instead connecting the sensor connector with the sensor side connector.

### BACKGROUND

The present invention relates to a seat load measuring device used in an occupant protection system that is provided with an occupant protection device, such as a seat belt device or an airbag device, is mounted in a vehicle, such as a motor vehicle, for measuring a seat load applied to a vehicle seat by the weight of the occupant seated on the vehicle seat, and an occupant protection system for controlling operation of the occupant protection device according to the seat load measured by the seat load measuring device.

In the related art, a vehicle, such as a motor vehicle, is provided with an occupant protection device, such as a seat belt device or an airbag device, and this device is intended for protecting an occupant when an extremely large speed reduction of the vehicle occurs in the case of an emergency, such as vehicle collision or the like, by restraining the inertial movement of the occupant.

The inertial force of the occupant varies according to the weight of the occupant seated on a seat of the vehicle. When the occupant protection device is controlled uniformly irrespective of the weight of the occupant, the performance of this occupant protection device cannot be executed effectively. In order to allow sufficient and effective function of this occupant protection device, an occupant protection system that controls the operation of the occupant protection device according to the weight of the occupant seated on the seat of the vehicle has been proposed in recent years. For example, in this occupant protection system adjustment of the magnitude of a seat belt pretension, or adjustment of an amount of deployment gas, or adjustment of airbag deployment speed is performed according to the weight of the occupant.

In order to control the operation of the seat belt device or the airbag device according to the weight of the occupant seated on the seat of the vehicle, it is necessary to determine the weight of the occupant. For this purpose, a seat load measuring device for measuring the weight of the seated occupant in the seat of the vehicle has been proposed. For example, see Japanese Unexamined Patent Application Publication Number 2000-258234.

The seat load measuring device as described above is provided with a plurality of load sensors including, for example, a strain gauge or the like for detecting the magnitude of the load applied on the seat of the vehicle by the weight of the occupant. Seat load detection signals detected by the plurality of the load sensors are transmitted to an electronic control unit (ECU) of the seat belt device or the ECU of the airbag device, and the ECU controls operation of the seat belt device or the airbag device based on the seat load.

In order to transmit the seat load detection signals from the plurality of the load sensors to the respective ECU, it is necessary to electrically connect the respective load sensors with the ECU. Accordingly, in the related art, an occupant protection system provided with a seat load measuring device in which the respective load sensors are electrically connected with the ECU with wire harnesses has been proposed in Japanese Unexamined Patent Application Publication Number 2001-12998.

As shown in FIG. 6, the seat load measuring device 1 in the occupant protection system in Japanese Unexamined Patent Application Publication Number 2001-12998 includes a pair of left and right load sensors 2, 3, sensor side connectors 4, 5 provided integrally with the respective load sensors 2, 3, and a pair of left and right wire harnesses 14, 15 provided with sensor connectors 6, 7 detachably connected to the respective sensor side connectors 4, 5 at one ends and ECU connector 12, 13 detachably connected respectively to the ECU connectors 10, 11 of the ECU 9 which controls operation of the occupant protection device 8 such as the seat belt device or the airbag device at the other ends. In FIG. 6, reference numeral 16 designates an ECU side connector of the ECU 9, reference numeral 17 designates an occupant protection device side connector of the occupant protection device 8, and reference numeral 18 designates a wire harness provided integrally at one end with an ECU connector 19 that is detachably connected to the ECU side connector 16 and at the other end with an occupant protection device connector 20 that is detachably connected to the occupant protection device side connector 17.

A pair of the left and right load sensors 2, 3 are fixed respectively to a vehicle floor so as to extend in the fore-and-aft direction (left and right direction in the drawing) at a predetermined distance in the lateral direction (vertical direction in the drawing) from each other, and are disposed in a pair of left and right seat brackets 21, 22 for supporting a vehicle seat, not shown. The respective load sensors 2, 3 are adapted to detect the seat load transmitted from the vehicle seat to the load sensors 2, 3. Then signals detected by the respective load sensors 2, 3 are transmitted to the ECU 9 via the left and right harnesses 14, 15. The ECU 9 measures the seat load by a calculation based on the detection signals of the seat load, and controls the operation of the occupant protection device 8 based on the obtained seat load.

However, in such a seat load measuring device 1 the left and right harnesses 14, 15 are necessary for electrically connecting the respective left and right load sensors 2, 3 with the ECU 9. Furthermore, both ends of the harnesses 14, 15 are integrally provided with the left and right load sensors 2, 3 and the connectors 6, 7, 12, 13 for connecting with the ECU 9. Therefore, the number of parts is increased and the structure of the seat load measuring device 1 is complicated, hence making the cost of the seat load measuring device 1 high.

Although not shown, it is necessary to provide not only a bracket for fixing the ECU 9 to the vehicle body or the vehicle seat, but also a predetermined number of clips are necessary for fixing the respective harnesses 14, 15. Therefore, the number of parts increases further and the structure becomes complicated even further, and cost is further increased.

In view of such circumstances, there is a desire to provide a seat load measuring device, and an occupant protection system using the same device, with a simple structure that has fewer parts and is capable of reducing cost.

### SUMMARY OF THE INVENTION

In order to achieve the object described above, a seat load measuring device according to an embodiment of the present invention includes a predetermined number of load sensors for detecting a seat load applied to a vehicle seat and an electronic control unit for calculating and processing the seat load based on detection signals of the seat load from the predetermined number of the load sensors integrated therein.

According to an embodiment of the present invention, a seat load measuring device includes at least a predetermined number of sensor side connectors provided on a predetermined number of load sensors and a sensor connector to be connected to one of the predetermined number of sensor side connectors detachably and electrically, characterized in that the sensor connector and the electronic control unit are integrated with each other, and a detection signal of the seat load from a load sensor is transmitted to the electronic control unit by connecting the sensor connector and the one sensor side connector.

According to an embodiment of the present invention, a seat load measuring is characterized in that a plurality of load sensors are provided so that each sensor is provided with sensor side connectors and the sensor side connectors are connected to sensor connectors that are integrated with the electronic control unit.

According to an embodiment of the present invention, a vehicle occupant protection system is provided that includes an occupant protection device and a seat load measuring device according to one of the previous embodiments of the present invention, characterized in that the electronic control unit is an electronic control unit for controlling operation of the occupant protection device.

Because the electronic control unit for calculating and processing the seat load can be integrated in the seat load measuring device, a harness for connecting the electronic control unit with the seat load measuring device and parts, such as fixtures for fixing the harness or the electronic control unit, may be eliminated. The need of wiring the harness may also be eliminated. Accordingly, the structure of the seat load measuring device can be simplified and the cost may be reduced effectively.

In particular, because the sensor connector and the electronic control unit can be integrated with each other, a sensor connector can be connected to a sensor side connector of a load sensor detachably and electrically without using a harness. Therefore, the number of harnesses can be reduced by one in comparison with the related art, the structure of the seat load measuring device can be simplified, and the cost may be reduced correspondingly.

Since the necessity of a harness can be eliminated, the necessity of the clips used for fixing the harness can also be eliminated. Furthermore, the electronic control unit can be fixed by connecting the sensor connector with the sensor side connector. Therefore, the necessity of a mounting member, such as a bracket, for fixing the electronic control unit can be eliminated. Therefore, the number of parts can be further reduced, the structure of the seat load measuring device can be simplified, and the cost of the seat load measuring device can be further reduced.

When an electronic control device according to one of embodiments described above is included in a vehicle occupant protection system, the electronic control unit for controlling the operation of an occupant protection device can be integrated in the seat load measuring device so that the structure of the seat load measuring device can be simplified, the entire occupant protection system can be reduced in size, and the space needed for installing the occupant protection system in the vehicle can be reduced, creating enhanced flexibility for installation of the occupant protection system into the vehicle.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a drawing schematically showing an example of an embodiment of a seat load measuring device according to the present invention.

FIG. 2 is a perspective view partly exploded of a load sensor in the example shown in FIG. 1 and a portion related thereto.

FIG. 3 is a plan view showing a portion of the load sensor shown in FIG. 2 in an assembled state.

FIG. 4 is a partial perspective view showing a part of the connector for connecting to the other load sensor of an example shown in FIG. 1.

FIG. 5 is a partial perspective view showing a part of another example according to the embodiment of the present invention.

FIG. 6 is a drawing schematically showing an example of a seat load measuring device in the related art.

### DETAILED DESCRIPTION

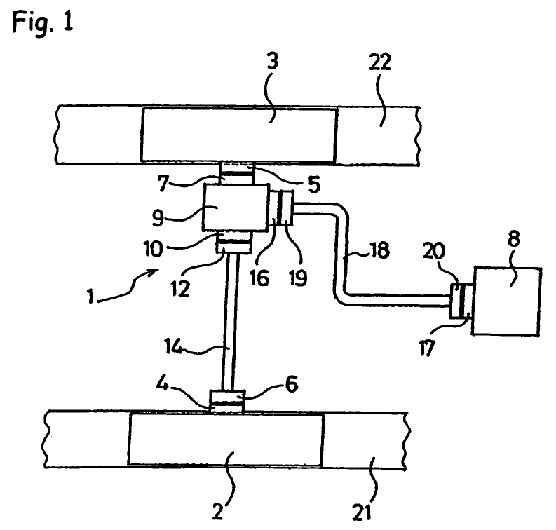

FIG. 1 schematically shows an example of an embodiment of the seat load measuring device according to the present invention. The same parts as the seat load measuring device and the vehicle seat in the related art shown in FIG. 6 are represented by identical numerals, whereby the description is omitted.

As shown in FIG. 1, an occupant protection system of this example includes a seat load measuring device 1, an occupant protection device 8, such as a seat belt device or an airbag, and an ECU 9 for controlling the operation of the occupant protection device 8.

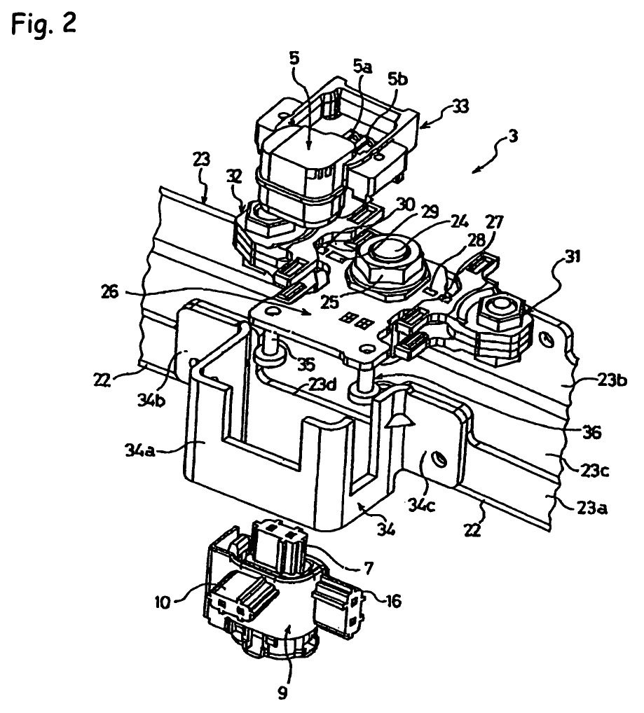

The seat load measuring device 1 is provided so that the ECU 9 is integrated with the right sensor connector 7 that is detachably and electrically connected to the sensor side connector 5 of the right load sensor 3. In other words, the ECU 9 is integrated in the seat load measuring device 1. As shown in FIG. 2, the right load sensor 3 is provided on a base frame 23 and the base frame 23 is fixed to a right seat bracket 22.

The load sensor 3 in the seat load measuring device 1 of this example will be described further in detail. Like the seat load measuring device 1 disclosed in the related art, the load sensor 3 includes a sensor substrate 26 that further includes a spring material fixed to the base frame 23 with a bolt 24 and a nut 25. The sensor substrate 26 is provided with four strain resistances 27, 28, 29, 30 on the upper surface of the sensor substrate 26 and load transmitting members 31, 32 are attached to the sensor substrate 26 so as to clamp the four strain resistances 27, 28, 29, 30. The load transmitting members 31, 32 are intended to transmit the seat load to the sensor substrate 26. In addition, the load sensor 3 includes a connector case 33 and the sensor side connector 5 is integrally provided with the connector case 33.

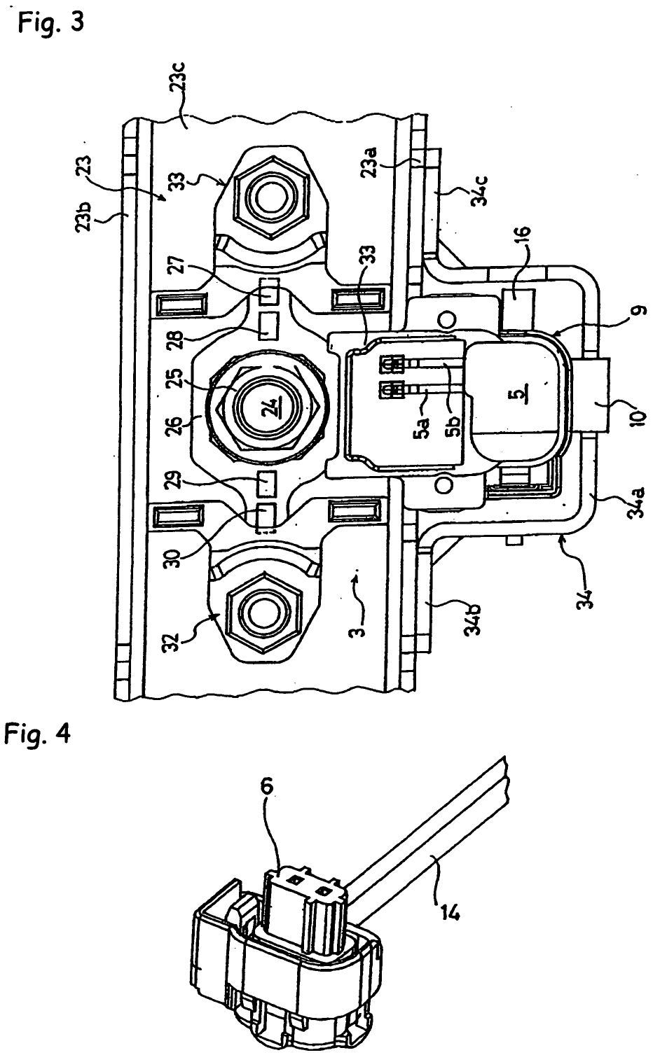

As shown in FIG. 2 and FIG. 3, the base frame 23 includes left and right base side walls 23a, 23b and a bottom portion 23c formed into a U-shape in cross section. A base frame 23 is formed with a notch 23d on the left base side wall 23a, and a protector 34 is fixed to the left base side wall 23a on the outer surface of the base side wall 23a corresponding to the notch 23d so as to protrude toward the left side. The protector 34 is formed with a U-shaped protecting portion 34a and mounting flange portions 34b, 34c formed on both ends of the protecting portion 34a by bending a band-shaped plate. The mounting flange portions 34b, 34c are fixed to the left base side wall 23a.

The connector case 33 is mounted to the upper surface of the sensor substrate 26 via case fixing screws 35, 36. Inside the notch 23d of the base frame 23 and the protector 34 the sensor side connector 5, part of the connector case 33, and part of the sensor substrate 26 are provided. Accordingly, even if the base frame 23 goes down by any chance when mounting the base frame 23 to the vehicle body or when transporting the base frame 23, the protector 34 can reliably protect the precision components of the occupant protection system, such as the sensor substrate 26 of the load sensor 3 or the sensor side connector 5.

The sensor substrate 26 is formed with a film including an insulating layer for insulating electricity, a wiring layer, and a resistant layer. With this film forming method, the aforementioned four strain resistances 27, 28, 29, 30 are provided as the strain sensors to the sensor substrate 26. The four strain resistances 27, 28, 29 30 are connected so as to form bridge circuits respectively, and the bridge circuits are connected to terminals 5a, 5b of the sensor side connector 5.

When the sensor connector 7, with the ECU 9 integrated therewith, is connected to the sensor side connector 5, the sensor connector 7 and the ECU 9 are positioned inside the protector 34. Therefore, the sensor connector 7 and the ECU 9 are reliably protected by the protector 34 like the sensor substrate 26 and the sensor side connector 5.

In the seat load measuring device 1 of this example, the ECU side connectors 10, 16 are formed like the sensor connector 7 and are integrated with the ECU 9. In other words, the sensor connector 7, the ECU 9, the ECU side connectors 10, 16 are integrated, and the ECU 9 and the respective connectors 7, 10, 16 are electrically connected to each other.

A left load sensor 2 will also be described. Although the specific structure of the left load sensor 2 and part of the structure relating to the left load sensor 2 are not shown, they are described by the same reference numerals as those of the right load sensor 3 for the convenience of description.

The left load sensor 2 is provided on the base frame 23 fixed to a left seat bracket 21. In this case the load sensor 2, the right sensor side connector 4, the base frame 23, the bolt 24, the nut 25, the sensor substrate 26, the four strain protectors 27, 28, 29, 30, the load transmitting members 31, 32, the connector case 33, the protector 34, and the case fixing screws 35, 36 are provided bilaterally symmetrical with those of the right load sensor 3.

As shown in FIG. 4, since the sensor connector 6 to be connected to the left sensor side connector 4 is not integrated with the ECU 9, the thickness of the sensor connector 6 is smaller than the thickness of the sensor connector 7. The left harness 14 is electrically connected to the sensor connector 6. The ECU connector 12, the ECU connector 19, and the occupant protection device connector 20 have the same structure as the sensor connector 6. Furthermore, the harnesses 14, 18 are fixed to the vehicle body or the vehicle seat via clips as needed as in the related art, though they are not shown.

Because the thickness of the sensor connector 6 is small, the protector 34 of the left load sensor 2 may be formed to a size that is sufficient to protect the sensor substrate 26 of the load sensor 2, the sensor side connector 4, and the sensor connector 6 that is connected to the sensor side connector 4, and hence the width of the protector 34 of the left load sensor 2 is set to a value smaller than the width of the right protector 34 (the vertical length in FIG. 2). The left and right protectors 34 may instead be formed into the same size for sharing or interchanging of parts, as a matter of course.

In the seat load measuring device 1 configured as described above, the left and right load sensors 2, 3, the occupant protection device 8, and the ECU 9 are electrically connected as shown in FIG. 1, respectively. In this case, the ECU 9 is integrated with the sensor connector 7 and is fixed to and supported by the sensor side connector 5, with the sensor connector 7 being connected and fixed to the sensor side connector 5.

When the occupant is seated on the vehicle seat, the load corresponding to the seat load of the vehicle seat in the state in which the occupant is seated is transmitted to the sensor substrate 26 via the load transmitting members 31, 32. Then, since the sensor substrate 26 is bent according to the transmitted load, the resistant values of the respective four strain resistances 27, 28, 29, 30 vary depending on the seat load. Accordingly, a current based on the varied respective resistant values is transmitted as a seat load detection signal from the left load sensor 2 via the sensor side connector 4, the sensor connector 6, the harness 14, the ECU connector 12, and the ECU side connector 10, and from the right load sensor 3 via the sensor side connector 5, the sensor connector 7 to the ECU 9 respectively.

As in the related art, the ECU 9 calculates and processes the seat load by the transmitted seat load detection signal, and controls the operation of the occupant protection device 8 based on the obtained seat load.

Other structures and other effects of the seat load measuring device 1 not shown in FIG. 2 and FIG. 3 are substantially the same as a seat load measuring device disclosed in the related art and can be understood easily by referring to the related art, such as Japanese Unexamined Patent Application Publication Number 2000-258234.

According to the seat load measuring device 1 of this example of the current invention, because the ECU 9 is integrated within the seat load measuring device 1, the necessity of the harness for connecting the ECU 9 to the seat load measuring device 1 and parts such as fixtures for connecting the harness or the ECU 9 can be eliminated. Furthermore, the necessity of the wiring of the harness can also be eliminated. Accordingly, the structure of the seat load measuring device 1 can be simplified, and its cost can be effectively reduced. In particular, since the sensor connector 7 and the ECU 9 of the occupant protection device 8 are integrated, components may be eliminated in comparison to a conventional seat load measuring device 1 of the related art, as shown in FIG. 6, such as the right harness 15 for connecting the right load sensor 3 and the ECU 9, the ECU side connector 11, and the ECU connector 13. Accordingly, the number of harnesses can be reduced by one in comparison with the related art, and hence the structure of the seat load measuring device 1 can further be simplified, whereby the cost can be reduced correspondingly.

Since the harness 15 is not used, clips for fixing the harness 15 may also be eliminated. Furthermore, since the ECU 9 is fixed by connecting the sensor connector 7 with the sensor side connector 5, a bracket for fixing the ECU 9 may also be eliminated. Therefore, the number of parts can be reduced further, the structure of the seat load measuring device 1 can be simplified, and the cost can be further reduced.

Furthermore, when an occupant protection system is provided with an occupant protection device 8, such as a seat belt device, an airbag device, or the like, that is used together with the seat load measuring device 1 of present invention, the structure of the seat load measuring device 1 can be simplified, and hence the entire occupant protection system may be reduced in size, whereby the space required for installing the occupant protection system in a vehicle may be reduced, and the flexibility of installing the occupant protection system in a vehicle may be enhanced.

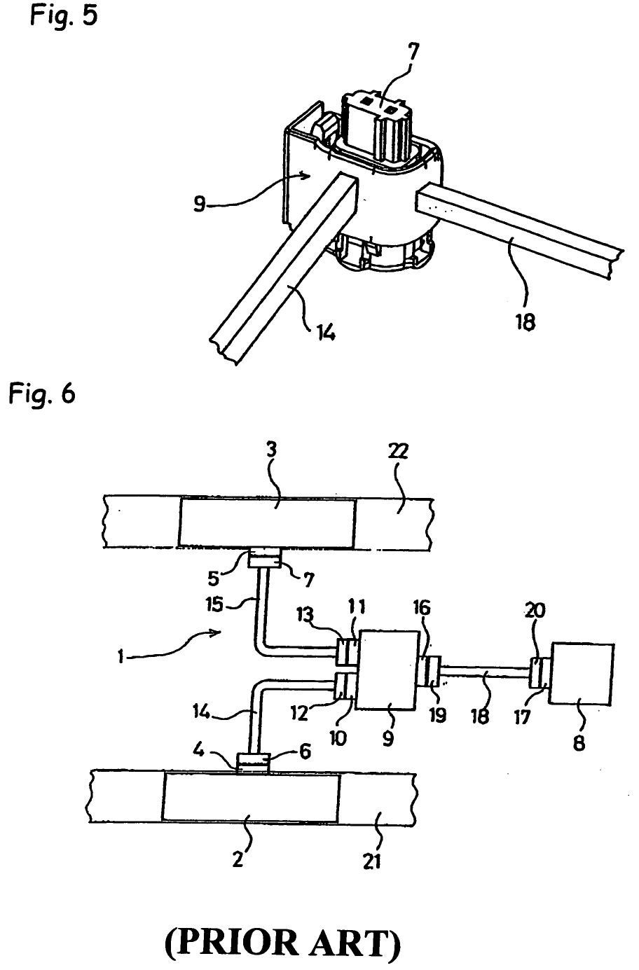

In the example described above, the right sensor connector 7 and the ECU 9 are integrated. However, it is also possible to integrate the ECU 9 with the left sensor connector 6. Also, in the example described above, although the ECU side connectors 10, 16 are integrated with the ECU 9, as shown in FIG. 1, FIG. 2, it is also possible to omit the ECU side connectors 10, 16, and extend the harnesses 14, 18 directly from the ECU 9, as shown in FIG. 5. In this case, the ECU connectors 12, 19 that are provided on the harnesses 14, 18 can also be omitted.

Furthermore, although a seat load measuring device 1 employing two load sensors is applied in the example described above, the invention is not limited thereto, and it is also possible to apply the same to a seat load measuring device 1 that employs one or more arbitrary load sensors.

Still further, although the ECU 9 is an ECU which calculates and processes the seat load by the detection signal of the seat load and controls the operation of the occupant protection device 8 in the example described above, the ECU may be used to only calculate and process the seat load by using the detection signal of the seat load.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A seat load measuring device comprising: a predetermined number of load sensors for detecting a seat load applied to a vehicle seat and an electronic control unit for calculating and processing the seat load based on detection signals of the seat load from the predetermined number of load sensors, wherein the electronic control unit is integrated with the device.

2. The seat load measuring device of claim 1, wherein the device includes a predetermined number of sensor side connectors respectively connected to the predetermined number of load sensors and sensor connectors to be detachably and electrically connected to said sensor side connectors, wherein one or more sensor connectors and said electronic control unit are integrated with each other, wherein a detection signal of the seat load from a load sensor is transmitted to the electronic control unit by respectively connecting said one or more sensor connectors with a sensor side connector that is connected to the load sensor.

3. The seat load measuring device of claim 1, wherein the device includes a plurality of load sensors and sensor side connectors for each of the plurality of the load sensors, wherein the sensor side connectors are detachably and electrically connected to sensor connectors.

4. A seat load measuring device comprising:
a plurality of load sensors for detecting a seat load applied to a vehicle seat;
an electronic control unit for calculating and processing the seat load based on detection signals of the seat load from the plurality of load sensors;
a plurality of sensor side connectors connected to the plurality of load sensors; and
sensor connectors to be detachably and electrically connected to said sensor side connectors, wherein a sensor connector and said electronic control unit are integrated with each other.

5. The seat load measuring device of claim 4, wherein the device includes:
a first harness for transmitting a signal from a load sensor to the electronic control unit;
a second harness for transmitting a signal from the electronic control unit to an occupant protection device;
wherein the first harness and second harness are directly connected to the electronic control unit.

6. An occupant protection system comprising:
an occupant protection device;
a seat load measuring device that includes a predetermined number of load sensors for detecting a seat load applied to a vehicle seat and an electronic control unit for calculating and processing the seat load based on detection signals of the seat load from the predetermined number of load sensors, wherein the electronic control unit is integrated with the device;
wherein the occupant protection device is configured to be used together with the seat load measuring device;
wherein the electronic control unit controls operation of the occupant protection device.

7. The occupant protection system of claim 6, wherein the occupant protection device is a seatbelt.

8. The occupant protection system of claim 6, wherein the occupant protection device is an airbag.

9. The occupant protection system of claim 6, wherein the seat load measuring device is installed in a vehicle, the load sensors are installed in seat brackets, and the electronic control unit is installed in a protector that is connected to one of the seat brackets.

10. The occupant protection system of claim 6, further including:
a predetermined number of sensor side connectors respectively connected to the predetermined number of load sensors; and
sensor connectors to be detachably and electrically connected to said sensor side connectors,
wherein one or more sensor connectors and said electronic control unit are integrated with each other.
